(19) United States
(12) Patent Application Publication
(10) Pub. No.: US 2011/0282724 A1
(43) Pub. Date: Nov. 17, 2011

(54) Reward Based Interactive Kiosk Advertising

(76) Inventor: Kevin Hwang, Las Vegas, NV (US)

(21) Appl. No.: 12/975,286

(22) Filed: Dec. 21, 2010

Related U.S. Application Data
(60) Provisional application No. 61/289,362, filed on Dec. 22, 2009.

(51) Int. Cl. G06Q 30/00

(52) U.S. Cl. 705/14.19

(57) ABSTRACT

A method of subsidizing purchases through consumer participation in interactive advertising at the kiosk includes providing a user an option to receive a subsidy towards a kiosk purchase, a promotional coupon, or a reward voucher in exchange for viewing an advertisement and participating in a corresponding survey. After presenting the advertisement and survey to the user, the kiosk provides a reward to the user at the kiosk or at a participating vendor.

### CROSS-REFERENCE TO RELATED APPLICATION

This application claims priority to U.S. Provisional Application Ser. No. 61/289,362, which was filed, Dec. 22, 2009, which is incorporated herein by reference in its entirety.

### TECHNICAL FIELD

This invention relates to interactive advertising, and more particularly to purchase subsidies or redemption of rewards for participating in such advertising.

### SUMMARY

In various implementations, one aspect of the invention features a method and platform for advertisers to directly compensate ad viewers for participation, e.g., for time, attention, input and demographic information, through redemption of an issued cash voucher or similar purchase subsidy.

In some implementations, Instant Reward Vouchers are issued to consumers for redemption on purchases from vendors at kiosk locations, e.g., at participating stores in a mall, at car washes, or at event venues.

In some implementations, consumers can choose to donate their reward vouchers as cash to any one of sponsored charities, e.g., through the kiosk at the time of issuance or later through a web-based interface.

In some implementations, consumers receive the reward vouchers after watching an entire ad and completing any additional requested interaction, e.g., survey responses, or complete other transactions such as in-ad purchases.

In some implementations, consumers can access a web-based interface from any computer to print coupons offered directly by selected advertisers at local kiosks. Customers can personalize their account settings to more directly influence the coupons or advertisements delivered. In some cases, the consumer can directly select coupons or advertisements.

In some implementations, consumers can actively choose to view brief, e.g., 30-second, advertisements featuring advertisers' latest promotions, discounts, and product trends specific to their interests. In some cases, consumers can print ad-related coupons in addition to reward vouchers that can be redeemed immediately to subsidize purchases at participating businesses of kiosk networks, e.g., in major gas stations, convenience stores, car washes, coffee shops, hotels, convention centers, and shopping malls.

In some implementations, a consumer interface allows registered members to deposit pre-paid credits to an account for future purchases at kiosks or other vending machines. In some cases, the consumer interface is accessed via a kiosk or personal computer.

In some implementations, registered members with pre-paid credits can purchase any dispensed items at participating vending machine by accessing their member credits on the vending machines interactive touch-screen.

In some implementations, registered members can print receipts for their purchases from the vending machines for record keeping purposes.

In some implementations, an advertiser interface or portal allows advertisers to upload coupons, ads, or other advertising materials for distribution to ad viewers at the kiosks.

In some implementations, advertisers can access a web-based interface to view real-time reward value bidding information including, e.g., current average, maximum and minimum bid prices to directly reward viewers for watching their ads at a given venue or through a given kiosk network.

In some implementations, an advertiser interface allows advertisers to input their advertised retail locations. This can allow users to request or receive driving directions from selected kiosks to participating advertiser retail locations. Thus, consumers can print vouchers and driving directions to the retail locations of advertisers of choices.

In some implementations, the interface allows advertisers to compose targeted post-video questions to prompt interaction with ad viewers at the kiosks following the delivery of ad messages. In some cases, advertisers can upload their unique post-video questions for their marketing campaigns through the advertiser interface. Advertisers can design their post-video questions in the form of multiple-choice, True or False, free text, etc.

In some implementations, customized survey questions accompany each advertisement video clip for viewer feedback. In some cases, a survey question is a trivial question regarding video content to ensure viewer's attention. In some cases, a survey question is a simple Multiple Choice or True or False question. In some questions, advertiser can establish bonus rewards for continued viewer feedback or for correct answers.

In some implementations, advertisers may reward viewers with an increase in the voucher cash value for correct answers and additional participation. The increased value can be automatically reflected in the printed vouchers.

In some implementations, advertisers can pre-set a number of times a video can be played on the selected kiosks in a given time period, e.g., per hour, per day or per week.

In some implementations, advertisers can designate maximum or specific amounts to be applied against advertiser accounts for a given time period, e.g., daily, weekly, or monthly. In some cases, advertiser spending can be based on a selected schedule of video plays on the selected kiosks.

In some implementations, advertisers can set a “cash reward value” for the vouchers given to viewers of their videos. In some cases, advertisers can “bid” against each other's cash reward values to get consumers' attention and sway advertisement viewing selection.

An advertiser interface can include up-to-date information on current maximum, minimum and average “bids” (cash reward values) for decision-making on setting voucher values.

In some implementations, coupons printed at the kiosk are stamped with location and time information for advertiser evaluation of coupon redemption and campaign effectiveness. In some implementations, demographics reports can show advertisers who are viewing their ads and define consumer shopping trends.

In some implementations, supplemental interaction, e.g., a Video Bonus Question (VBQ) feature, allows advertisers to gain customer insight with instant feedback on, products, services, sales promotions and video contents.

One aspect of the invention features an advertising subsidized vending machine, interactive point of sale terminal or “kiosk.” The kiosk includes a housing, video display visible on the housing, and a user interface accessible on the housing to a user. A special purpose computer is coupled to the display and user interface and is configured and programmed to provide advertisements via the display in response to user interaction with the user interface. A reward dispenser is operably coupled to the special purpose computer and configured to provide a reward for user participation in the form of credit towards a purchase.

In some cases, the reward dispenser includes a vending device and receptacle for a consumer article such as a drink, snack, card, or other consumer article.

In some implementations, the display and user interface together comprise an interactive touch screen.

In some implementations, the reward dispenser is configured to dispense at least one of drinks, food items, gift cards, and small consumer articles.

In some implementations, the special purpose computer is configured to accept user demographic information. In some cases, the demographic information is obtained from a magnetic card strip. In some cases, the user is requested to enter such information as part of the transaction or to enable more targeted selection and delivery of advertisements.

In some implementations, the dispenser is remotely wirelessly connected to the special purpose computer and is configured to receive electronic signals for authorization to vend items. For example, the kiosk including the special purpose computer may electronically communicate with a stand alone vending machine to facilitate subsidized vending machine purchases.

The kiosk may be a stand alone device, an upgrade or retrofit to a legacy device, or may be a remote component in a group of networked devices.

In some implementations, the reward dispenser comprises a printer configured to print at least one of promotional content, sales coupons and reward vouchers.

In some implementations, the kiosk further includes a Bluetooth or other wireless communications module configured to allow a user to wirelessly connect a portable device to the special purpose computer.

In some implementations, the kiosk includes at least one of a card reader, bar code scanner, RFID reader, smart chip reader, or other means of identifying users.

Another aspect of the invention features a method of subsidizing purchases at a kiosk through consumer participation in interactive advertising at the kiosk. The method includes providing a user an option to receive a subsidy towards a purchase in exchange for viewing an advertisement and participating in a survey. In response to a user election, the kiosk presents the advertisement and survey to the user; and provides a reward credit to the user for a purchase at the kiosk, at an associated vending machine or from a participating vendor.

In some applications, the reward credit comprises a partial or full subsidy applicable to a purchase from the kiosk.

In some applications, the kiosk is a vending machine.

In some applications, the method includes dispensing one of a drink, a prepaid card, a snack, promotional coupons, and any suitable consumer article.

In some applications, the reward credit is provided as a voucher redeemable at a vendor other than the kiosk.

In some applications, the reward credit is stored in an account associated with the user.

In some applications, the advertisement is at least one of a video clip, a survey, an audio clip, slideshow, or any combination of multimedia formats.

In some applications, the reward credit comprises a subsidy towards a kiosk rental transaction. In some cases, the rental transaction is a movie rental.

In some applications, the method further includes providing additional reward credits for participating in or viewing additional advertisements.

In some applications, the method further includes providing sufficient advertisements and reward credits to allow the user to fully subsidize a purchase transaction.

In some applications, the method further includes exchanging between the kiosk and a central database, via a network connection, updated advertisements and kiosk transaction data.

In some applications, the method further includes a personalized recommendation system for recommending purchases and promotions and selecting an advertisement to present to a user based on user specific data obtained at the kiosk or stored on a central database.

In some applications, the method further includes transmitting an electronic authorization signal to vend an item.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a vending machine having an interactive display.

FIG. 2 is a flow chart of a method of subsidizing vended purchases through advertising on the interactive display.

FIG. 3 is another flow chart of method of providing rewards vouchers at a kiosk based on participation in advertising.

FIG. 4—Screen shot 40 illustrates the basic function and features that may be included in a main-menu type screen on the interactive display of the kiosk, or on the website or other outlet.

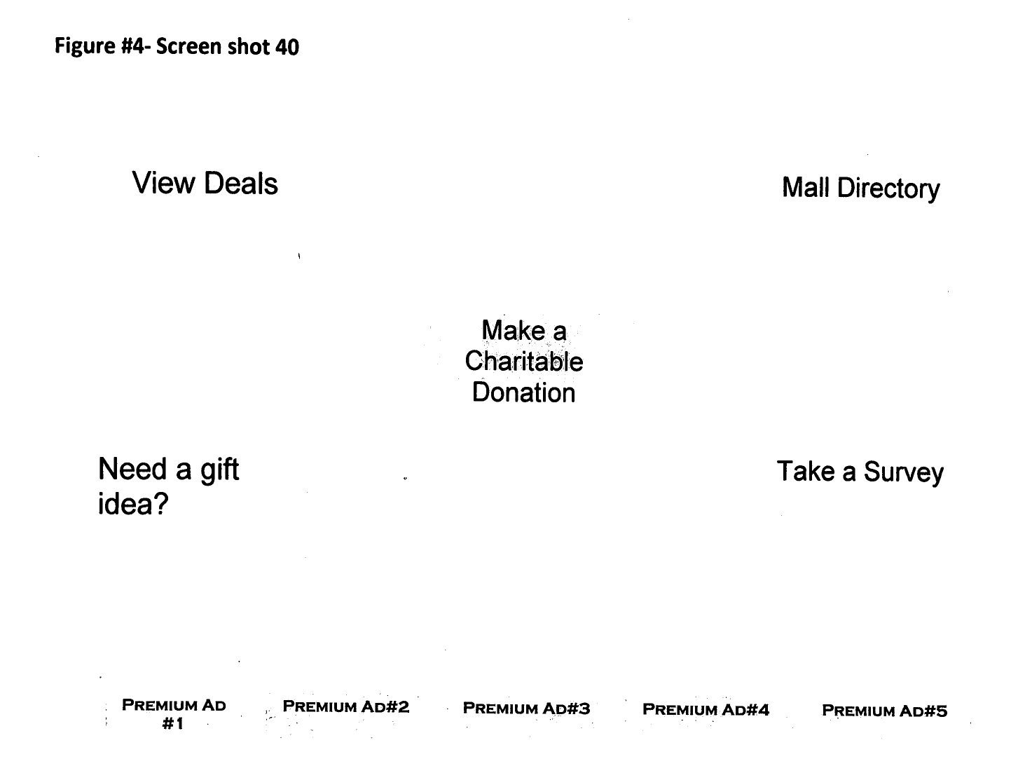

FIG. 5—Screen shot 50 illustrates the basic function and features that may be included regarding suggestions for gifts or other purchases on the interactive display of the kiosk, or on the website or other outlet.

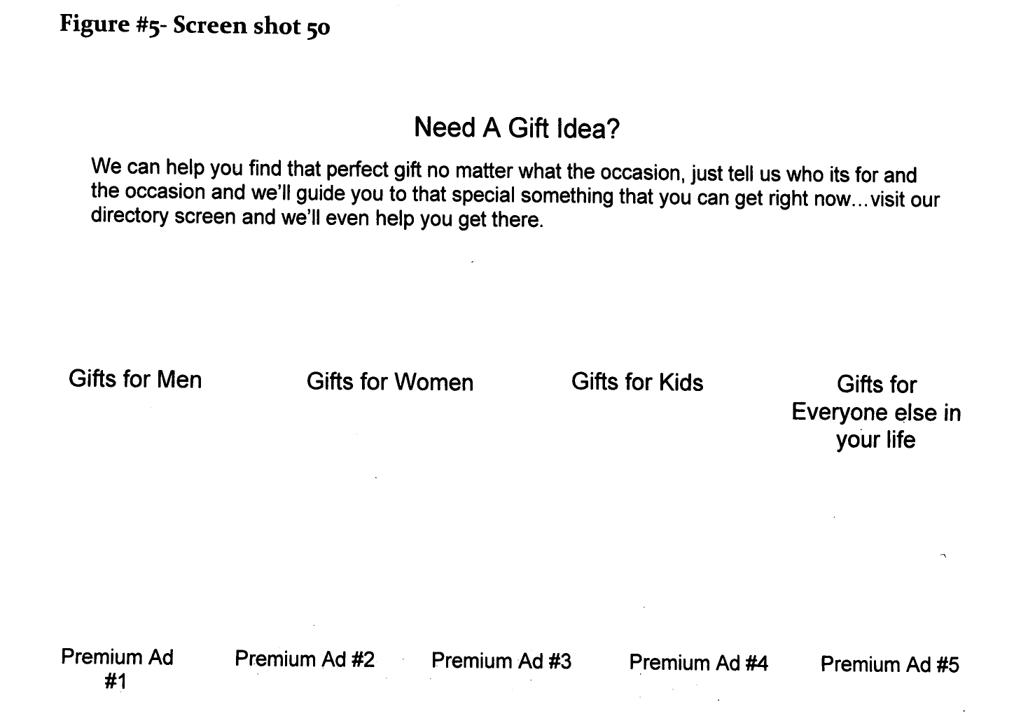

FIG. 6—Screen shot 60 illustrates the basic function and features that may be included regarding making a charitable donation on the interactive display of the kiosk, or on the website or other outlet.

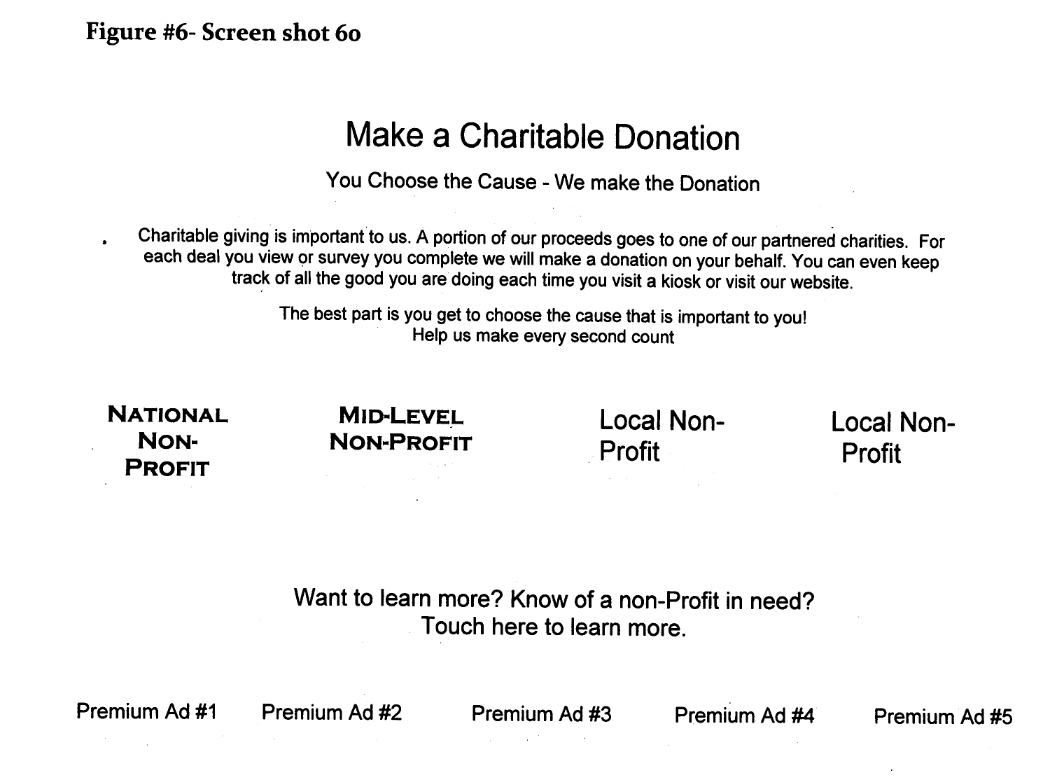

FIG. 7—Screen shot 40 illustrates the basic function and features that may be included regarding making a charitable donation on the interactive display of the kiosk, or on the website or other outlet.

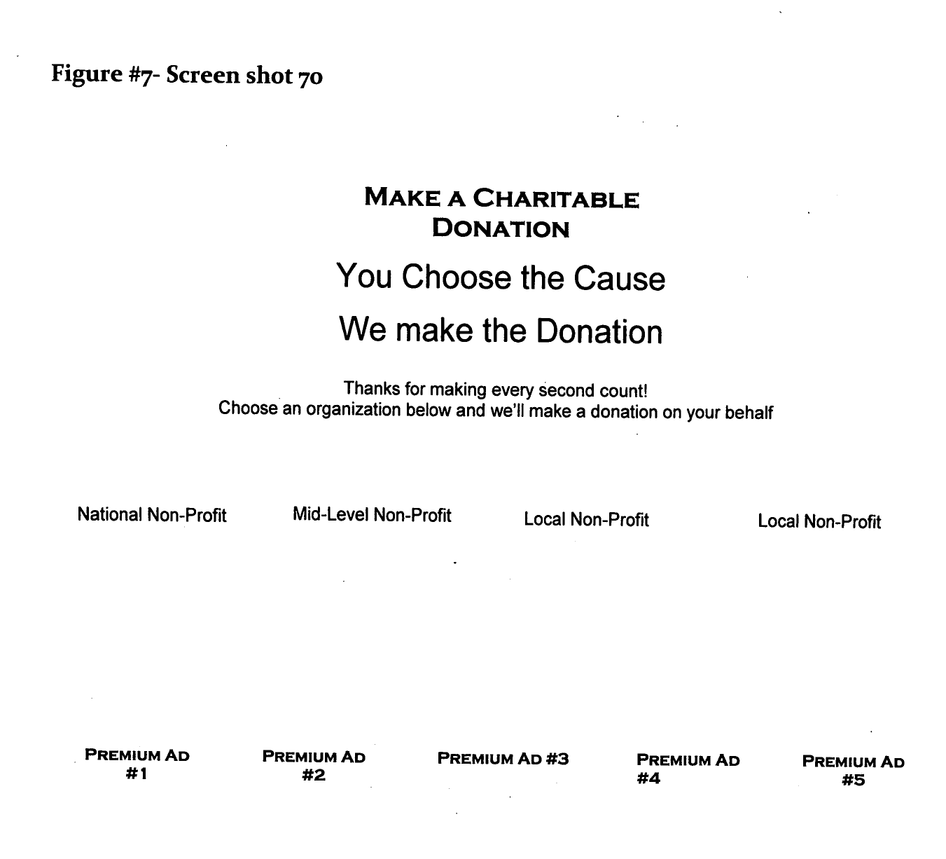

FIG. 8—Screen shot 40 illustrates the basic function and features that may be included for choosing promotional content to watch on the interactive display of the kiosk, or on the website or other outlet.

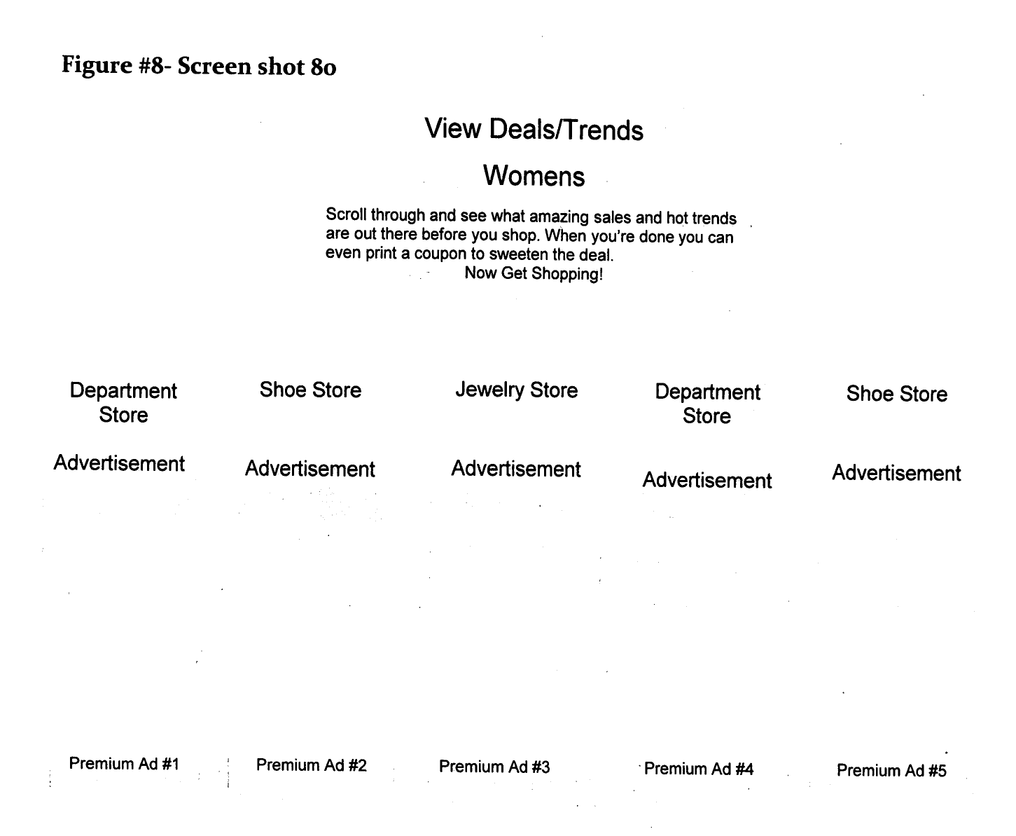

FIG. 9—Screen shot 40 illustrates the basic function and features that may be included for choosing promotional content to watch on the interactive display of the kiosk, or on the website or other outlet.

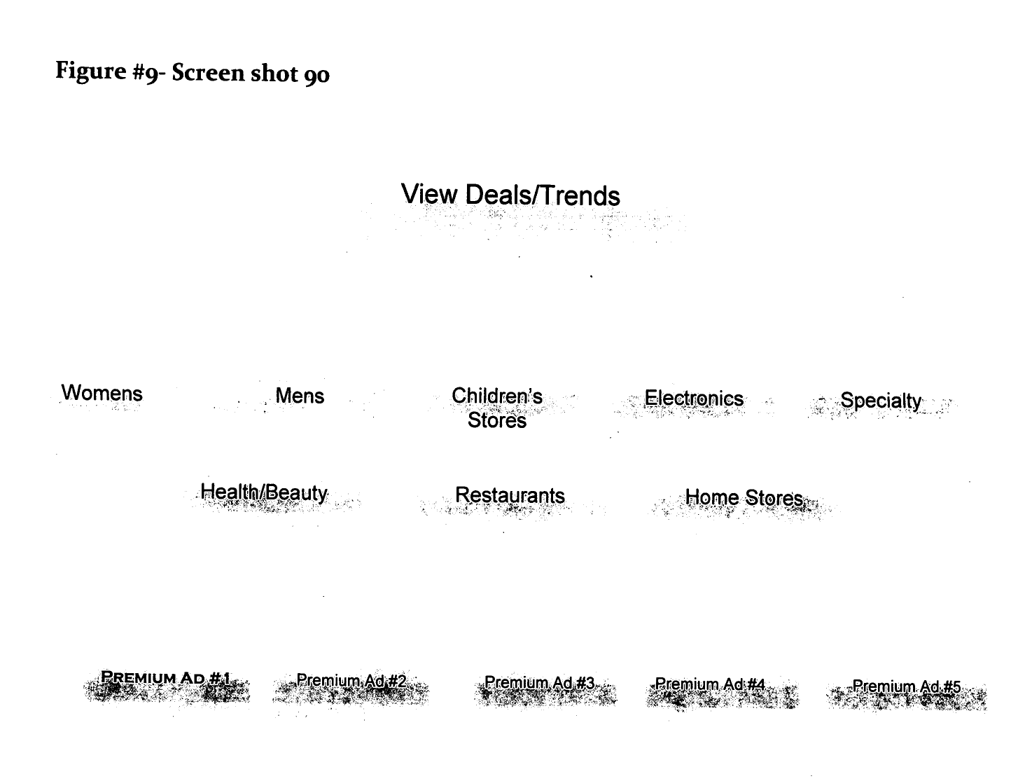

FIG. 10—Screen shot 40 illustrates the basic function and features that may be included for participating in surveys on the interactive display of the kiosk, or on the website or other outlet.

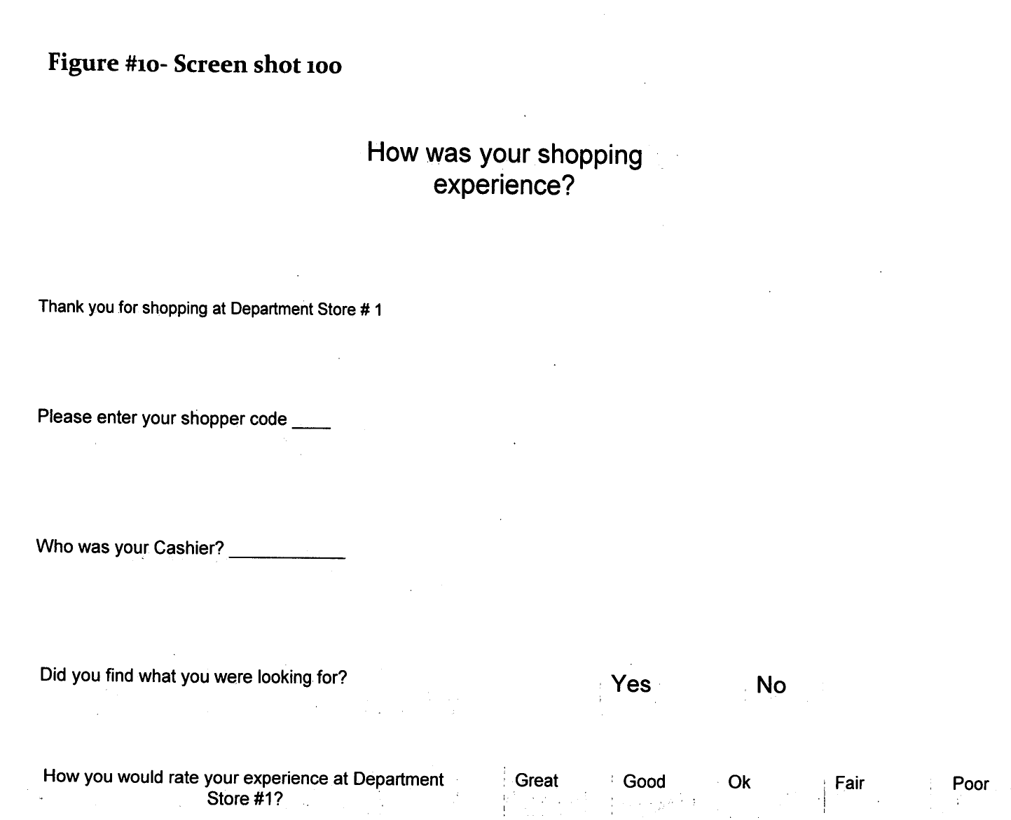

FIG. 11—Screen shot 40 illustrates the basic function and features that may be included for participating in surveys on the interactive display of the kiosk, or on the website or other outlet.

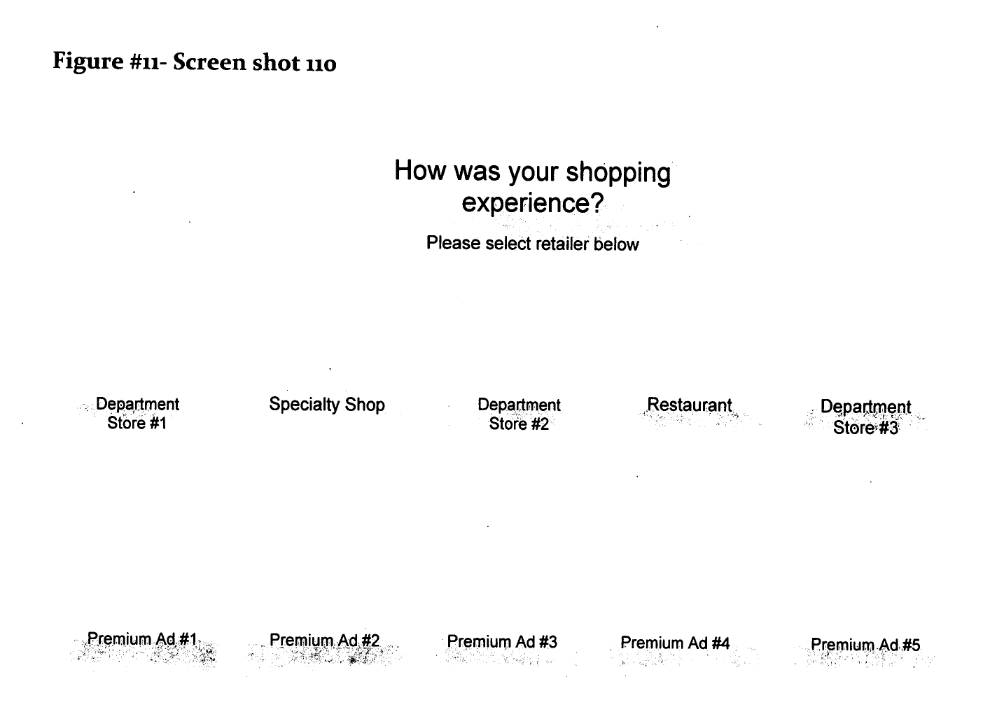

Like reference symbols in the various drawings indicate like elements.

### DETAILED DESCRIPTION

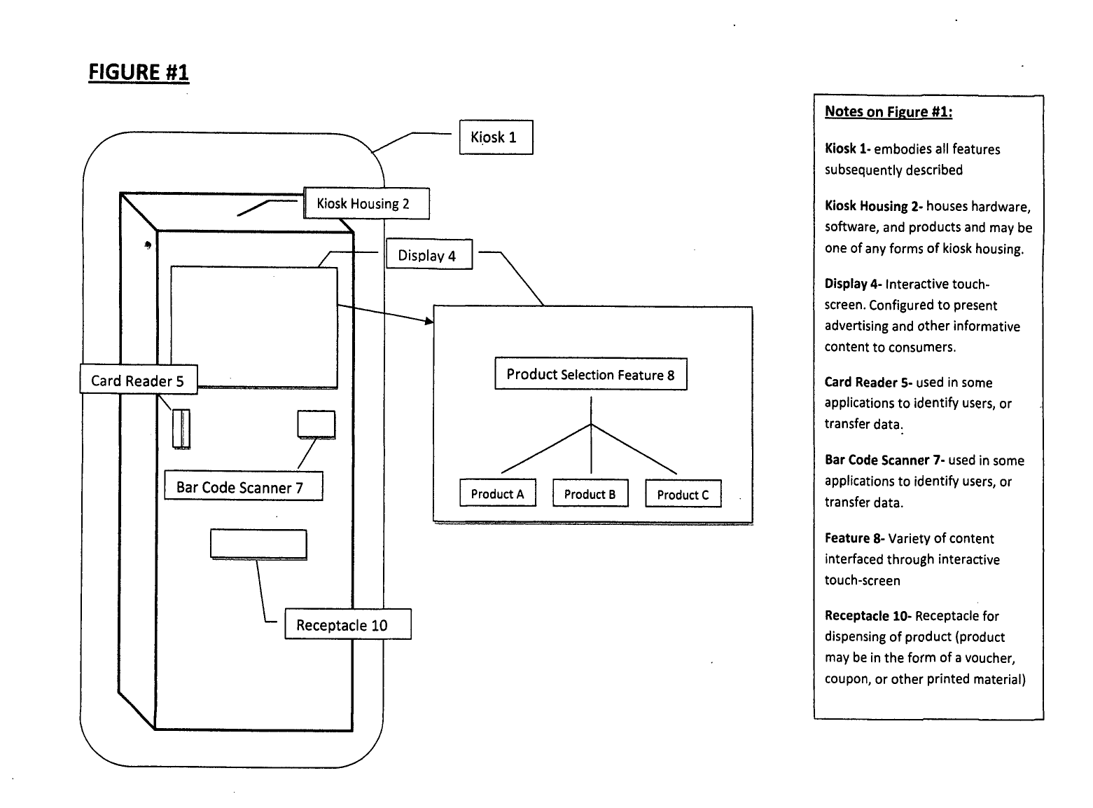

With reference to one implementation illustrated in FIG. 1, Kiosk 1 embodies features subsequently described herein. Housing 2 houses hardware, software, and products and may be one of any suitable form of kiosk housing such as a box-type, a touch screen/computer propped up on a stand, a self-contained touch screen/computer fastened to any supporting structure, or in some cases a conventional-style vending machine housing with a touch screen and computer integrated into it. Housing 2 includes an interactive display 4 configured to present advertising and other informative content to consumers. Display 4 invites or allows customers to elect to subsidize the purchase of an item to be vended or to be rewarded with coupons or other promotional material via viewing an advertisement and participating in a survey or the like. For example, a consumer may use product selection feature 8 to choose a beverage to be dispensed from receptacle 10. In some embodiments receptacle 10 is a printer that prints and dispenses coupons, vouchers, and the like. Feature 8 may be incorporated into the interactive display 4 or may be in the form of conventional mechanical buttons. Before or after selection of a particular product with feature 8, display 4 presents the opportunity for the consumer to subsidize all or part of a product purchase in exchange for viewing and or providing feedback to content provided via display 4. If partial subsidy is provided, the consumer completes the corresponding advertising participation via display 4, is charged the difference on the purchase price of the product and receives the dispensed product via receptacle 10. Similarly, multiple advertisements or more involved participation may be provided to augment or complete purchase subsidies. In some applications, one of card reader 5 or bar code scanner 7 may be used to identify a user, or transfer data.

In one application, rewards based interactive advertising is provided via an automated vending machine that allows the consumer (user) to watch and rate a brief commercial or to respond to a brief marketing survey on an interactive touch-screen. In some cases the commercial or survey can be of approximately one minute or less. The machine rewards the user for his/her time and effort with credit towards or a voucher for a complementary soft drink, juice, water, small article or food item of his/her choice. For example, the machine may allow the user to print off coupons or other promotional content.

In some applications, such reward vouchers or promotional coupons are also offered via other outlets including kiosks or websites, e.g., iadmedia.com, iadmedia.net, and applications for smart phones and other handheld devices.

In some cases, users may be provided the opportunity to choose a charity organization that will receive a portion of the revenue gained from each viewed advertisement.

The vending machines can be monitored, managed, and interfaced via web-based operations. For example, demographic data can be obtained from a user's magnetic card strip and can be used to select targeting advertising via one of the web-based operations.

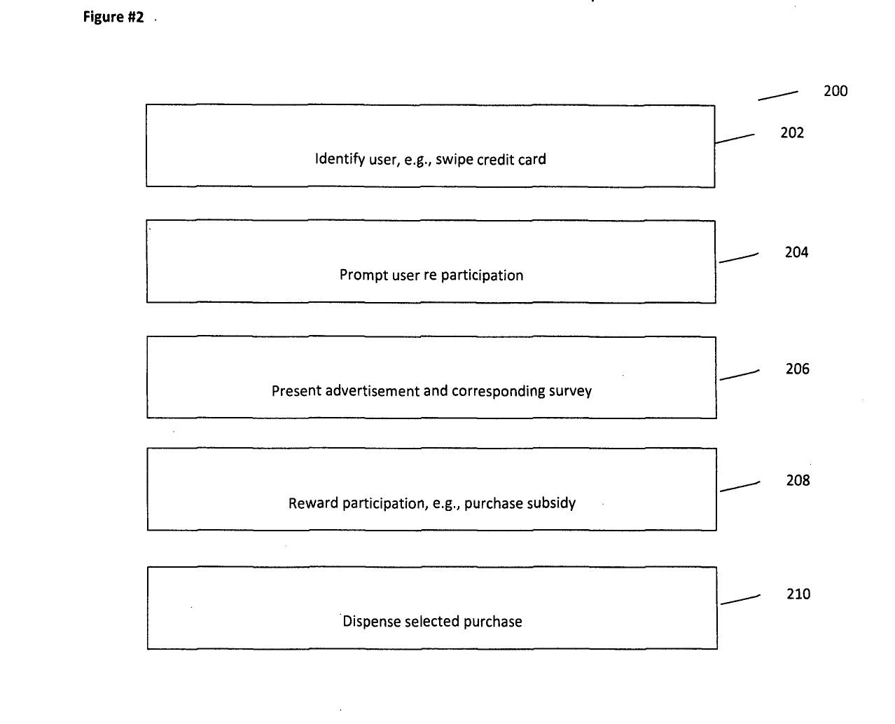

FIG. 2 is a flow chart of a method of subsidizing vended purchases through advertising on the interactive display. (200) The interactive vending machine can provide for login for identification verification at the point of usage, e.g. by entering a username or card number, or by scanning or swiping a card. (202) The user is then prompted to choose between watching a video advertisement, responding to a short marketing survey or proceeding directly to the purchase. (204) If the user opts to watch an advertisement, the vending machine requests the user to respond to an advertisement and/or answer other questions, e.g., to provide feedback or information about themselves, their shopping experiences, or preferences. (206) Upon the user answering the questions, the vending machine prompts the user to choose a reward, e.g., subsidized or free soft drink, juice, water, small article, food item, or rental. (208) The selected item is then dispensed. (210).

In some cases, the user may alternatively or additionally choose to participate in a short marketing survey. In some cases, users may be directed to the vending machine to participate in surveys after completing a purchase from a vendor, e.g., a participating iAd Media partner or client. In some cases, the vending machine prompts the user to enter a code found on a receipt or to choose the vendor and date of last purchase. This information is used to call a corresponding survey to appear. If this information is not available or applicable, the vending machine displays a survey based on the demographic information of the user, the shopping patterns of the user, the history of commercials viewed by the user through iAd Media, any combination of this information, or, alternatively, through random selection.

Transactions between the user and the vending machine or other iAd Media outlets comprise an exchange of a small amount of a user's time to watch a commercial or complete a survey in exchange for various reward(s), printed coupons, promotional information, purchase recommendations, or charitable donation.

In some implementations, users with mobile phones or laptop computers with Bluetooth connectivity can connect wirelessly with iAd Media's vending machines within connection range. Such connectivity allows multiple users to simultaneously watch commercials and participate in marketing surveys wirelessly on their Bluetooth devices. This will also allow users to move freely about instead of standing in front of the vending machines. Vouchers and coupons may be electronically delivered or displayed on the user's mobile device screens. Such electronic vouchers and coupons may be redeemed in a paperless scanned form, via display to a store clerk, or may simply be credited to an account for later redemption.

Users may create online accounts to receive access to watching commercials and participating in marketing surveys online with any interne capable computer or hand-held device. Such online content can be provided through, www.iAdMedia.com or through other affiliated websites. Rewards for online or remote activities can be provided at a physical location of a vending machine in the form of redeemable account credits or may be delivered in any suitable electronic or printed form for use at participating vending machines, kiosks or vendors.

Vending machine 2 is linked to a central database associated with a web-based service which is updated periodically with the information exchanged at each vending machine. With this system functionality, new commercials, marketing surveys, and other exchanges of information can be communicated and updated in real-time between the vending machine hard drive and the central database.

In another application, the rewards based interactive advertising is provided via an automated kiosk that allows the user to watch and rate a brief commercial or to respond to a brief marketing survey on its interactive touch-screen. The kiosk provides rewards in the form of a voucher for use at a remote vending machine or participating vendor for a complementary or subsidized soft drink, juice, water, small article or food item. The kiosk can include a printer to allow the user to print off the vouchers, coupons or other promotional content.

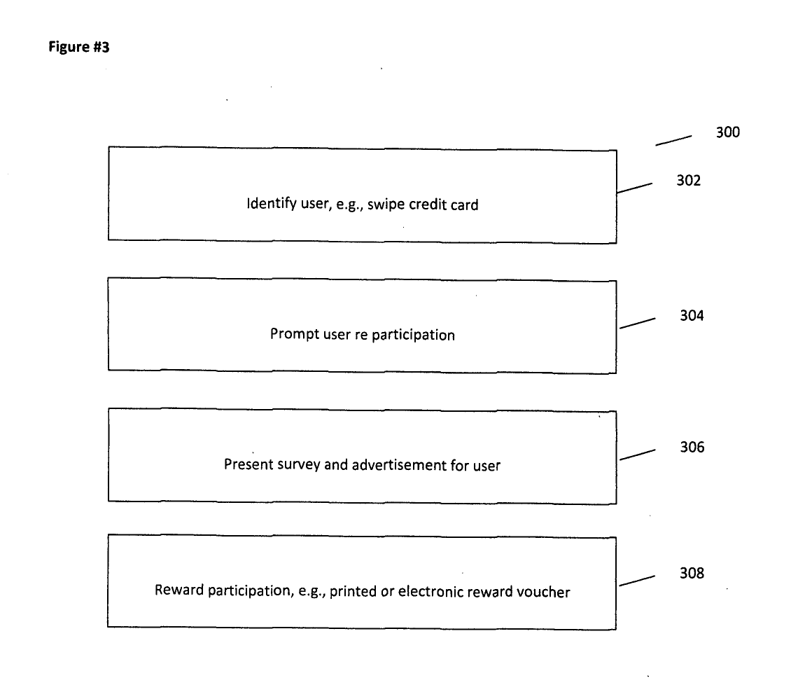

FIG. 3 is another flow chart of method of providing rewards vouchers at a kiosk based on participation in advertising. (300) The interactive kiosk can optionally incorporate a login for identification verification as previously described. (302) The user is prompted to choose between watching a video advertisement and responding to a short marketing survey. (304) If the user opts to watch an advertisement, the kiosk can request some interaction based on the advertisement. (306) For example, the kiosk may ask users to rate the quality of the advertisement and/or answer other questions to provide feedback or information, e.g., about themselves, their shopping experiences, and their preferences. After the user answers the questions, the kiosk provides the user with a reward. (308) The reward can be provided in the form of a printed or electronic voucher, coupon, or the like.

Alternatively or additionally, the user may choose to participate in a short marketing survey. For example, in some cases, users may be directed to the kiosk to participate in surveys after completing a purchase from a vendor. In some cases, the kiosk prompts the user to enter a code found on a receipt or to choose a vendor and date of purchase. This information prompts or calls a corresponding survey to appear on the kiosk display. If this information is not available or applicable, the kiosk may display a survey based on demographic information of the user, shopping patterns of the user, history of advertisements viewed by the user, any combination of this information, or through random selection.

Mobile phones, laptop computers or other mobile devices with Bluetooth connectivity can connect wirelessly with the kiosk as previously described. Vouchers and coupons can be displayed on the mobile device screens, e.g., via an onscreen bar code, and may be redeemed or credited to an account for later redemption. The kiosk is linked to a central database that is updated automatically with the information exchanged at each kiosk. Thus, new commercials, marketing surveys, and other exchanges of information can be communicated and updated in real-time between the kiosk hard drive and the central database.

In one example, the ad is generated and saved at a central database. The ad is then loaded onto kiosks via the internet. Ads are updated from the central database and viewing records and other kiosk transaction data is communicated back to the database to confirm advertising efficacy and further personalize future advertising. Depth of interaction and user feedback and survey data can be collected and transmitted to the central server. The feedback data is provided to appropriate advertisers to facilitate tailoring advertising or interaction based on the feedback.

The kiosk can be an integrated stand alone device such as a vending machine. Alternatively, the kiosk can be networked with a separate vending machine to send and receive electronic signals for authorization to vend items. The kiosk includes an interactive touch-screen for displaying advertisements and collecting survey information. An integrated printer can be used to print promotional content, sales coupons and reward vouchers for use at participating vendors.

In some implementations, a built-in Bluetooth unit allows users to connect with the kiosk via cell phones, PDA or laptop to view the advertisement or select a purchase remotely.

In some implementations, a card reader is used to read credit cards or account cards distributed by iAd Media. Similarly, a bar code scanner may be used to scan account cards distributed by iAd Media.

In some applications, the kiosk includes a special purpose computer running computer programming to perform real-time update and retrieval of new advertisements, surveys and transaction information archival between a central database and each kiosk or vending machine. The special purpose computer can include programming to enable transmitting electronic signals for authorization to vend items and account for all information related to each transaction.

In some applications, the special purpose computer includes programming to automatically collect, analyze and match user's demographic information and purchasing patterns to suitable marketing survey categories available from the central database through each kiosk.

In some applications, a mobile device such as an iPhone or other smart phone can be used to watch advertisements and claim rewards with instant promotional code or reward credits toward the users' registered accounts.

In some applications, advertisements and other promotional information can be accessed via the internet from any computer or device with internet capability.

In some implementations, existing vending machines can be retrofit or upgraded to provide user interaction-based advertising rewards for vended purchases. For example, software and/or web-based functionality as well as various hardware components can be added, such as a touch-screen and printer. Similarly, software and/or web-based functionality can associate users' accounts to bar codes, card scans, or card numbers.

A number of embodiments of the invention have been described. Nevertheless, it will be understood that various modifications may be made without departing from the spirit and scope of the invention. For example, a kiosk can be a point of purchase or credit card check-out terminal in a vendor store. Accordingly, other embodiments are within the scope of the following claims.

What is claimed is:

1. An advertising subsidized kiosk comprising:
a kiosk housing;
a video display visible on the housing;
a user interface accessible to a user on the housing;
a special purpose computer coupled to the display and user interface and configured to provide advertisements via the display and to record a user response from user interaction via the user interface corresponding to a respective presented advertisement;
a reward dispenser operably coupled to the special purpose computer and configured to provide a reward for the user interaction in the form of credit towards a purchase.

2. The kiosk of claim 1, wherein the display and user interface together comprise an interactive touch screen.

3. The kiosk of claim 1, wherein the reward dispenser is configured to dispense at least one of drinks, food items, gift cards, cash value vouchers, and small consumer articles.

4. The kiosk of claim 1, wherein the special purpose computer is configured to obtain demographic information about the user.

5. The kiosk of claim 4, wherein the demographic information is obtained from a magnetic card strip.

6. The kiosk of claim 1, wherein the dispenser is wirelessly connected to the special purpose computer and is configured to receive electronic signals for authorization to vend items.

7. The kiosk of claim 1, wherein the reward dispenser comprises a printer configured to print at least one of promotional content, sales coupons, cash value vouchers and reward vouchers.

8. The kiosk of claim 1, further comprising a Bluetooth communications module configured to allow a user to wirelessly connect a portable device to the special purpose computer.

9. The kiosk of claim 1, further comprising at least one of a card reader, bar code scanner, RFID reader and smart chip reader.

10. A method of subsidizing purchases at a kiosk through consumer participation in interactive advertising at the kiosk, the method comprising:
providing a user an option to receive a subsidy towards a purchase in exchange for viewing an advertisement and participating in a survey regarding the advertisement;
in response to a user election, presenting the advertisement or survey to the user; and
providing a reward credit to the user at the kiosk.

11. The method of claim 10, wherein the reward credit comprises a subsidy applicable to one of a purchase and a rental from the kiosk.

12. The method of claim 10, wherein the kiosk is a vending machine, the method further comprising dispensing one of a drink, prepaid card, snack, promotional coupon, and small consumer article.

13. The method of claim 10, wherein the reward credit is provided as a voucher redeemable at a participating vendor other than at the kiosk.

14. The method of claim 10, wherein the reward credit is stored in an account associated with the user.

15. The method of claim 10, wherein the reward credit comprises a subsidy towards a kiosk rental transaction.

16. The method of claim 15, wherein the rental transaction is a movie rental.

17. The method of claim 10, further comprising providing additional reward credits for additional advertisements and additional user interaction.

18. The method of claim 10, further comprising providing sufficient sequential advertisements, user interaction opportunities and reward credits to allow the user to fully subsidize a kiosk transaction.

19. The method of claim 10, further comprising exchanging between the kiosk and a central database, via a network connection, updated advertisements and kiosk transaction data.

20. The method of claim 10, further comprising selecting an advertisement to present to a user based on user specific data obtained at the kiosk or stored on a central database.

21. The method of claim 10, further comprising transmitting an electronic authorization signal to one of a kiosk and a participating vendor to vend an item.
